(19) United States
(12) Patent Application Publication
(10) Pub. No.: US 2011/0103916 A1
(43) Pub. Date: May 5, 2011

(54) BOLT FOR PANEL COMBINATION AND PANEL COMBINATION METHOD USING THE SAME

(75) Inventors: Chul Kim, Hwaseong (KR); Jae Hwan Jung, Pyungtaek (KR)

(73) Assignee: HYUNDAI MOTOR COMPANY, Seoul (KR)

(21) Appl. No.: 12/787,985

(22) Filed: May 26, 2010

(30) Foreign Application Priority Data
Nov. 2, 2009 (KR) 10-2009-0105017

(51) Int. Cl. F16B 39/32; F16B 39/28; B23P 11/00

(52) U.S. Cl. 411/114; 411/378; 411/354; 29/525.11

(57) ABSTRACT

The present invention features a bolt for panel combination that includes a flange formed along an external circumference of a bolt head, a screw portion, of which an end is formed as a cone, combining a plurality of panels and a plurality of taps that are formed to the flange for the bolt to be fixed when the bolt is tightened. The present invention also features a panel combination method that includes forming a burred portion to a first panel by burring and punching, disposing a second panel, on which a bolt hole is formed, and corresponding a position of the burred portion, inserting the bolt for panel combination into the bolt hole and tightening the bolt to the burred portion in order to combine the first panel and the second panel.

### CROSS-REFERENCE TO RELATED APPLICATION

This application claims under 35 U.S.C. §119(a) priority to and the benefit of Korean Patent Application No. 10-2009-0105017 filed in the Korean Intellectual Property Office on Nov. 2, 2009, the entire contents of which are incorporated herein by reference.

### BACKGROUND OF THE INVENTION

(a) Field of the Invention

The present invention relates, generally, to a bolt for panel combination, and to a panel combination method using the bolt. More particularly, the present invention relates to a bolt for panel combination and to a panel combination method using the bolt that may enhance rigidity and maintain fastening torque.

(b) Description of the Related Art

In the process of manufacturing a vehicle, 20,000 to 30,000 elements are assembled.

Generally, a vehicle body is formed as B.I.W (body in white), in which the car body sheet metal (including doors, hoods, and deck lids) has been assembled or designed.

In this process, about thousands elements, such as panels, are developed for making a vehicle and each of the panels are formed, pressed, trimmed, pieced, flanged, hemmed and so on.

For combining the above said panels, as shown in FIG. 5 for example, in the conventional art a first panel 7 and a second panel 5, bolt holes 3 and 1 are respectively formed, and are disposed in the panels. A weld nut 9 is then welded to the first panel 7 by welding and a bolt 11 is fastened through the bolt hole 1 formed to the second panel 5 to the weld nut 9. Thus, the combination of the first and second panel 7 and 5 is completed.

However, in the conventional process, for welding the weld nut 9 to the panel, investment in a plant and suitable equipment is required.

Further, welding to a thin panel may cause deformation of the panel.

Accordingly, there is a need in the art for improved bolts for panel combination and methods for using the same.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention provides a bolt for panel combination and a panel combination method using the bolt where the bolt preferably has an advantage of suitably enhanced rigidity and suitably maintained fastening torque without a weld nut.

Preferably, a bolt for panel combination according to an exemplary embodiment of the present invention may include a flange suitably formed along an external circumference of a bolt head, a screw portion, of which an end is formed as a cone, combining a plurality of panels and a plurality of taps that are formed to the flange for the bolt to be fixed when the bolt is tightened.

Preferably, the taps may be formed along a circumference of the flange.

Preferably, the tap may include a slanted surface and a vertical surface, and the slanted surface may be suitably formed along a tightening direction of the bolt.

According to certain preferred embodiments, the screw portion may preferably be a triangular thread and directly connected to the panel.

A panel combination method according to an exemplary embodiment of the present invention may include suitably forming a burred portion to a first panel by burring and punching, suitably disposing a second panel, on which a bolt hole is formed, corresponding to a position of the burred portion, suitably inserting the bolt for panel combination into the bolt hole and tightening the bolt to the burred portion in order to combine the first panel and the second panel.

Preferably, the panel combination method may further include reverse forming for securing an area of the burred portion by drawing process.

According to certain preferred embodiments, the burred portion may be formed to inside of the first panel and length of the burred portion is 3.7 mm -6.0 mm.

According to other preferred embodiments, the panel combination method may further include compensating of the panel for loss of thickness of the panel.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated by the accompanying drawings which are given hereinafter by way of illustration only, and thus are not limitative of the present invention, and wherein:

FIG. 1 is a perspective view of a bolt for panel combination according to an exemplary embodiment of the present invention.

FIG. 2 is a front view of a bolt for panel combination according to an exemplary embodiment of the present invention.

FIG. 3 is another perspective view of a bolt for panel combination according to an exemplary embodiment of the present invention.

FIG. 4 is a drawing showing panel combination method using the bolt according to an exemplary embodiment of the present invention.

FIG. 5 is a drawing showing panel combination method according to a conventional art.

Reference numerals set forth in the Drawings includes reference to the following elements as further discussed below:

| 100: panel | 101: first panel |
|---|---|
| 103: second panel | 105: bolt hole |
| 110: burred portion | 111: hole |
| 120, 121, 122, 123: first metallic pattern | |
| 126: punch hole | 125: burring recess |
| 130, 131, 132, 133: second metallic pattern | |
| 135: burring protrusion | 136: punch |
| 200: bolt | 210: bolt head |
| 220: flange | 230: screw portion |
| 221: tap | 223: slanted surface |
| 225: vertical surface | |

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION OF THE EMBODIMENTS

As described herein, the present invention features a bolt for panel combination comprising a flange formed along a circumference of a bolt head, a screw portion, and a plurality of taps.

In one embodiment, the flange is formed along the external circumference of the bolt head.

In another embodiment, the end of the screw portion is formed as a cone.

In another further embodiment, the plurality of taps are formed to the flange for the bolt to be fixed when the bolt is tightened.

The present invention also features a panel combination method comprising forming a burred portion to a first panel by burring and punching, disposing a second panel, on which a bolt hole is formed, corresponding to a position of the burred portion, inserting the bolt for panel combination of any one of the aspects described herein into the bolt hole, and tightening the bolt to the burred portion in order to combine the first panel and the second panel.

An exemplary embodiment of the present invention is described herein with reference to the accompanying drawings.

While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

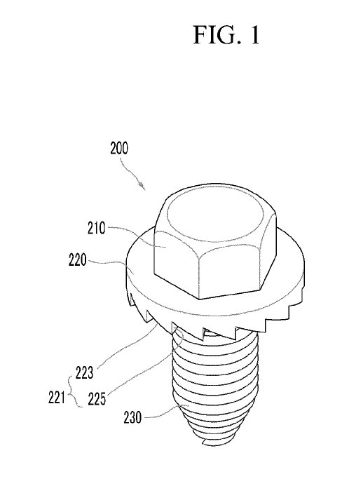

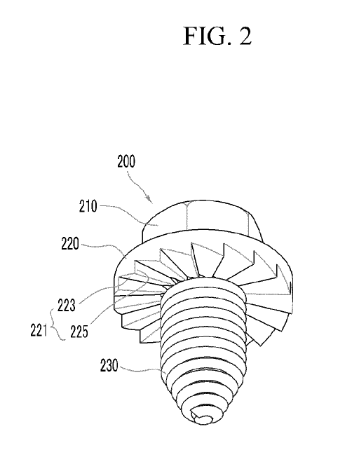

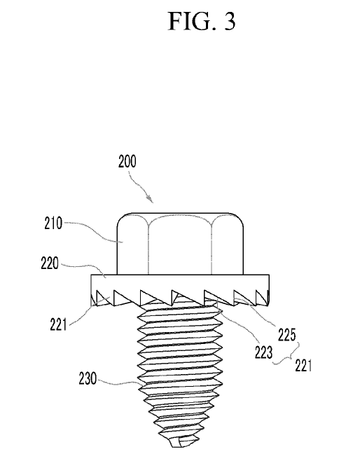

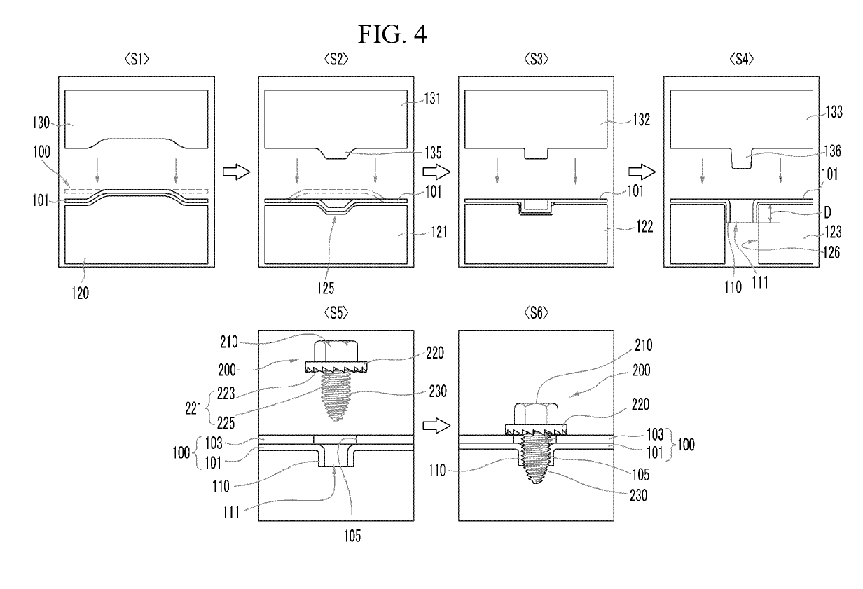

According to certain preferred embodiments, FIG. 1 and FIG. 3 are perspective views of a bolt for panel combination. FIG. 2 is a front view of a bolt for panel combination according to a further preferred exemplary embodiment of the present invention. FIG. 4 is a drawing showing a panel combination method using the bolt according to another further exemplary embodiment of the present invention.

According to a preferred embodiment of the present invention, a bolt 200 for panel combination preferably includes a flange 220 formed along an external circumference of a bolt head 210 and a screw portion 230 combining a plurality of panels.

Preferably, a plurality of taps 221, as shown in FIG. 3, are suitably formed to the flange 220 for the bolt 200 to be fixed when the bolt 200 is tightened to panels 100.

Preferably, the taps 221 are formed along a circumference of the flange 200.

Preferably, the tap 221 includes a slanted surface 223 and a vertical surface 225, and the slanted surface 223 is suitably formed along a tightening direction of the bolt 200.

Accordingly, when tightening the bolt 200, the bolt 200 may easily rotate on the panel 100 by contacting the slanted surface 223 to the panel 100.

In further preferred embodiments, after completing tightening the bolt 200, catching of the vertical surface 225 to the panel 100 may prevent the bolt 200 from being suitably loosened.

Preferably, an end of the screw portion 230 is formed as a cone.

In other further embodiments, the screw portion 230 is a triangular thread and is directly connected to the panel 100.

Accordingly, when the bolt 200 is suitably tightened to the panel 100, the screw portion 230 formed as a triangular thread forms threads to the panel 100 so that fastening torque can be suitably maintained.

A panel combination method using an exemplary bolt of the present invention is described with reference to FIG. 4.

A panel combination method using a bolt 200 according to an exemplary embodiment of the present invention preferably includes forming a burred portion 110 to a first panel 101 by burring and punching, suitably disposing a second panel 103, on which a bolt hole 105 is formed, corresponding a position of the burred portion 110. In further preferred embodiments, a panel combination method further includes inserting the bolt 200 into the bolt hole 105 and tightening the bolt 200 to the burred portion 110 in order to combine the first panel 101 and the second panel 103.

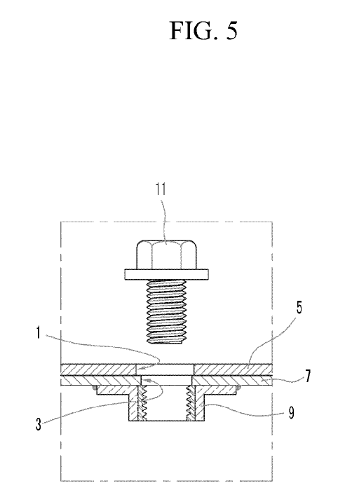

According to certain exemplary embodiments, for example as shown in S1 of FIG. 5, the first panel 101 is suitably disposed to a first metallic pattern 120 and a second metallic pattern 130 presses the first panel 101, that is the first panel 101 is reverse formed for securing an area of the burred portion by drawing process.

Preferably, after reverse forming of the first panel 101, as shown in S2 of FIG. 5, the first panel 101 is suitably disposed to a first metallic pattern 121, in which a burring recess 125 shaped as a slanted, and then a second metallic pattern 131, in which a burring protrusion 135 is formed, suitably presses the first panel 101.

According to further preferred embodiments, for compensating of the panel for loss of thickness of the panel, as shown in S3 of FIG. 5, the first panel 101 is suitably disposed to a first metallic pattern 122, shaped as a step, and then a second metallic pattern 132, shaped as a step, suitably presses the first panel 101.

After a compensating process, as shown in S4 of FIG. 5, the first panel 101 is suitably disposed to a first metallic pattern 123, in which a punch hole 126 is formed, and then a second metallic pattern 132, in which a punch 136 is formed, presses to punch the first panel 101.

Further, then a hole 111 for the bolt 200 to be engaged is suitably formed to the burred portion 110.

Preferably, in further preferred embodiments, the burred portion 110 is suitably protruded from the first panel and length of the burred portion is 3.7 mm -6.0 mm for securing strength of combination.

While this invention has been described in range of the burred portion from 3.7 mm to 6.0 mm, it is to be understood that the range of the burred portion may be varied according to a length of the screw portion 230 of the bolt 200 and required strength of the combination of the panels.

According to further preferred embodiments, then a second panel 103, on which the bolt hole 105 is formed, is suitably disposed to a position corresponding to a position of the burred portion 110, and the bolt 200 is suitably tightened, for example as shown in S5 and S6 of FIG. 5.

Preferably, in this process, the screw portion 230 forms screws to inside of the burred portion 110 and the bolt 200 is suitably connected to the burred portion 110.

Accordingly, by enhancing rigidity and maintaining fastening torque, the first and second panels 101 and 103 can be suitably combined by connecting the bolt 200 to the burred portion 110 without weld nut or other assistant elements.

Further, the taps 221 formed undersurface of the flange 220 may suitably prevent the bolt 200 from being loosened after tightening the bolt 200.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A bolt for panel combination comprising:
a flange formed along an external circumference of a bolt head;
a screw portion, of which an end is formed as a cone, combining a plurality of panels; and
a plurality of taps that are formed to the flange for the bolt to be fixed when the bolt is tightened.

2. The bolt of claim 1, wherein the taps are formed along a circumference of the flange.

3. The bolt of claim 1, wherein the tap comprises a slanted surface and a vertical surface,
and the slanted surface is formed along a tightening direction of the bolt.

4. The bolt of claim 1, wherein the screw portion is a triangular thread and is directly connected to the panel.

5. A panel combination method comprising:
forming a burred portion to a first panel by burring and punching;
disposing a second panel, on which a bolt hole is formed, corresponding to a position of the burred portion;
inserting the bolt for panel combination of claim 1 into the bolt hole; and
tightening the bolt to the burred portion in order to combine the first panel and the second panel.

6. The panel combination method of claim 5, wherein the panel combination method further comprises reverse forming for securing an area of the burred portion by drawing process.

7. The panel combination method of claim 5, wherein the burred portion is formed to inside of the first panel and length of the burred portion is 3.7 mm -6.0 mm.

8. The panel combination method of claim 5, wherein the panel combination method further comprises compensating the panel for loss of thickness of the panel.

9. A bolt for panel combination comprising:
a flange formed along a circumference of a bolt head;
a screw portion; and
a plurality of taps.

10. The bolt of claim 9, wherein the flange is formed along the external circumference of the bolt head.

11. The bolt of claim 9, wherein the end of the screw portion is formed as a cone.

12. The bolt of claim 9, wherein the plurality of taps are formed to the flange for the bolt to be fixed when the bolt is tightened.

13. A panel combination method comprising:
forming a burred portion to a first panel by burring and punching;
disposing a second panel, on which a bolt hole is formed, corresponding to a position of the burred portion;
inserting the bolt for panel combination of the claim 9 into the bolt hole; and
tightening the bolt to the burred portion in order to combine the first panel and the second panel.
